(19) United States
(12) Patent Application Publication
(10) Pub. No.: US 2008/0229342 A1
(43) Pub. Date: Sep. 18, 2008

(54) METHOD FOR PICKING AND PLACING A DISC

(76) Inventors: Dale K. Kubin, San Diego, CA (US); Nathan P. Scherdin, San Diego, CA (US)

Correspondence Address: DOBRUSIN & THENNISCH PC, 29 W LAWRENCE ST, SUITE 210, PONTIAC, MI, 48342, US

(21) Appl. No.: 11/844,740

(22) Filed: Aug. 24, 2007

Related U.S. Application Data
(60) Provisional application No. 60/895,170, filed on Mar. 16, 2007.
(60) Provisional application No. 60/945,206, filed on Jun. 20, 2007.

(51) Int. Cl. G11B 17/04

(52) U.S. Cl. 720/619

(57) ABSTRACT

The present invention provides a disc transport having an improved design for providing efficient operation and improved engagement to one or more storage discs. In one aspect, the present invention provides a disc transport having a disc engagement mechanism and an engagement area including the at least one disc having a disc hole, wherein the at least one disc is generally misaligned with the at least one engagement area, one or more discs therebelow, the disc engagement mechanism thereabove, or combinations thereof. The engagement mechanism is moved in a generally parallel direction to that of the at least one disc to generally align the at least one disc with the at least one engagement area, the one or more discs therebelow, the disc engagement mechanism thereabove, or combinations thereof. In another aspect, the present invention provides a method for aligning at least one disc within an engagement area.

### CLAIM OF PRIORITY

The present invention claims the benefit of the priority of the filing date of U.S. Provisional Application Ser. No. 60/895,170 filed Mar. 16, 2007 and Provisional Application Ser. No. 60/945,206 filed Jun. 20, 2007, which are herein incorporated by reference for all purposes.

### TECHNICAL FIELD

The field of the present invention relates to disc transport devices and more particularly to disc engagement mechanisms adapted to selectively engage storage devices and to align storage devices prior to and/or after the transfer of the storage device to a target region.

### BACKGROUND OF THE INVENTION

Media device manufacturers currently provide consumers with disc publishing devices configured for processing media (such as storage discs, or otherwise). Such processing requires the use of a disc transport for engagement of storage discs and movement to the one or more media components of the publishing devices for processing therein. Typically, the storage bins of disc publishing devices contain a plurality of storage discs that are stacked in a generally vertical fashion; however, rarely are the inner rings of the storage discs perfectly aligned. The storage discs within the storage bin are usually staggered even when the storage bin has outer support rods or walls used to retain the storage discs stacked therein. Accordingly, since the storage discs are often staggered, the inner rings of the storage disc are not always in the same location from storage disc to storage disc within the storage bin, which creates problems during the engagement of the staggered disc.

Current disc transports used to engage, (pick), storage discs for transporting can coupe with the staggered storage discs to some degree, but often fail to completely compensate for the non-aligned storage discs. The disc transport is usually programmed to pick from a fixed point along a horizontal axis, (i.e., generally parallel to the storage disc). The end result being a failure to pick the staggered storage disc when the inner ring of the storage disc in not aligned to the predetermined location.

Furthermore, even once the disc transport has picked a storage disc and transferred it to a target location, additional disc alignment issues may occur. For example, rarely do any two media components, such as a recording device and/or a printer assembly, have movable trays that open their respective trays exactly alike, nor does the respective movable trays always open to the same position during the opening or closing of the movable tray. As a result, the placement of the storage disc onto the movable tray is not always accurate since the predefined, (preprogrammed), placement point can alter slightly from the actual placement of the movable tray when it does not completely open or the movable tray has shifted slightly to one side. This in turn causes the system to error and requires human intervention upon disc obstruction, during the retraction of the movable tray into the recording device.

In view of the forgoing, there is a need for a disc transport, which advantageously can align a stack of staggered storage discs, thereby enabling the engagement mechanism to engage and transport the storage disc to a target location. Furthermore, there is a need for a disc transport than can align a disengaged storage disc within the receptacle of a media component to enable further processing.

### SUMMARY OF THE INVENTION

The present invention overcomes the drawbacks of the prior art by providing a disc transport device having an improved design, which provides more efficient operation utilizing an improved alignment feature with respect to the engagement and the disengagement of storage discs.

In one aspect, the present invention meets the above needs by providing a disc transport device having alignment means adapted to operate in conjunction with the an engagement mechanism for locating and/or aligning at least one staggered storage disc. Accordingly, the disc transport swiftly moves the engagement mechanism in a generally parallel direction to that of the at least one storage disc, while applying a slight downward force, thereby locating and/or aligning the top disc for insertion of the engagement mechanism into the hole of the top disc.

In another aspect, the present invention provides a disc transport having an alignment feature capable of aligning a storage disc after disengagement from the engagement mechanism to a receptacle of a media component. Accordingly, after the storage disc is disengaged, the disc transport swiftly moves the engagement mechanism in a generally parallel direction to that of the storage disc to further align the storage disc about the receptacle of the media component, thereby preventing the storage disc from obstructing the retraction of the receptacle to a closed position within the media component.

The described method and apparatus dramatically increases the success rate of engaging a storage disc properly when an engagement, (pick), is attempted. By artificially locating, moving, settling, or aligning the storage disc with the describe method, the accuracy of the placement dramatically improves. With this technology, a self-serve, unattended kiosk system is more reliable.

### BRIEF DESCRIPTION OF THE DRAWINGS

FIG. 1 is a perspective view of one aspect of the present invention.

FIG. 2 is a perspective view of another aspect of the present invention.

FIG. 3 is a perspective view of another aspect of the present invention.

FIG. 4 is a perspective view of one embodiment of the present invention.

### DETAILED DESCRIPTION OF THE INVENTION

The present invention provides a disc transport device and method for locating, engaging, aligning, and transporting one or more storage devices including, but not limited to: compact discs, digital video discs, the like, combinations thereof or otherwise. More specifically, the disc transport is adapted to provide a disc engagement mechanism for engaging discs. Advantageously, the improved disc transport with the disc engagement mechanism, can be adapted for use in a disc-publishing device for engaging and transferring storage discs to one or more media components for processing by way of printing, recording, and/or otherwise to a disc as disclosed in U.S. application Ser. No. 11/335,381 entitled “Printer” and is herein incorporated by reference for all purposes.

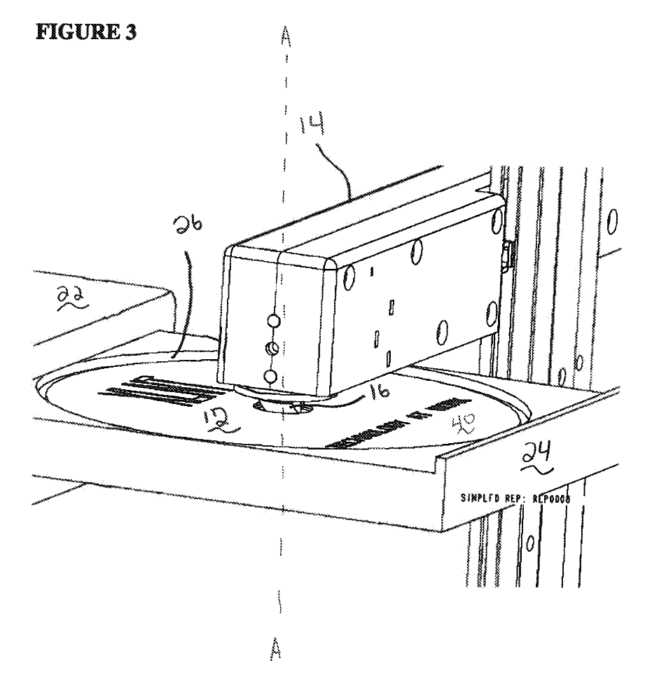

Accordingly, in one exemplary configuration, the present invention meets the above needs by providing a disc transport for transporting storage discs from a source location to a target. The disc transport includes an engagement mechanism that is capable of engaging or disengaging storage discs prior to or after transportation, respectively. Furthermore, the disc transport in combination with the engagement mechanism allows for locating and/or alignment of one or more storage discs for engagement thereof generally along an engagement axis with respect to one or more media components in communication with the disc transport. The engagement axis is a generally vertical axis extending through a (typically preprogrammed) location that is accessible to the disc engagement mechanism and the engagement area for engagement of the disc. For example, the engagement axis A-A (FIG. 3), is generally perpendicular to the top surface 40 of the disc 12 and preferably, generally extends through the hole 18 of the disc that is located within an extended movable tray. Preferably, each engagement axis is generally parallel to the second slide member and each engagement area includes an engagement axis (not shown). As such, in additional configurations, the disc transport is in communication with media components such as printing assemblies, recording devices, copying devices, playing devices, disc storage areas, combinations thereof or otherwise. Optionally or as an alternative, the disc transport in combination with the engagement mechanism allows for alignment of the engagement mechanism along an engagement axis with respect to one or more storage disc and/or the one or more media components in communication with the disc transport.

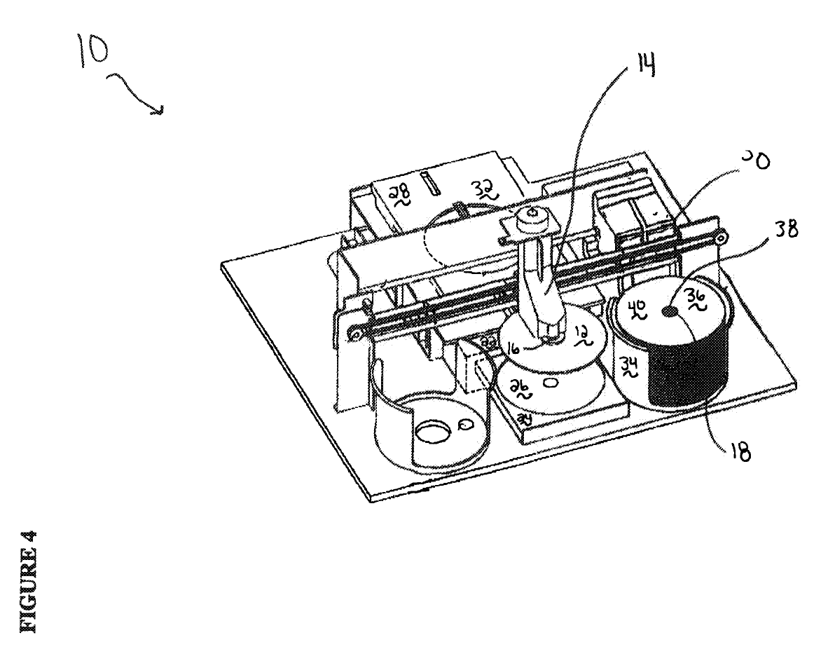

Referring to the drawings, exemplary embodiments and features of the present invention are shown. In one embodiment as shown in a disc-publishing device 10, (FIG. 4), the present invention provides a disc transport 14 adapted to engage and move one or more discs 12, preferably one at a time. The disc transport has independent movement capabilities and is controlled by a controller, which may be attached to the disc transport or may be part of another component of the disc-publishing device. Advantageously, the disc transport is configured with a disc engagement mechanism 16 that is adapted to engage a disc, preferably by supporting portions of the disc, for subsequent movement thereof.

The disc transport is adapted to move along a substantial portion of a first slide member. Accordingly, the device further includes drive means linkably attached to the disc transport, via a linkage or otherwise, to provide a suitable force to move the disc transport to various points along the first slide members. Suitable drive member may include a stepper motor or other suitable drive members used for moving a disc transport component along a bearing surface or the like. Suitable linkages include belts, cables, chains, screws, the like or otherwise. In a preferred embodiment, the linking mechanism comprises a belt. However, it should be appreciated that numerous types of drive assemblies and linkages are available and may be used, as are commonly utilized in the design of inkjet printers.

The first slide member may comprise of any member adapted to guide an attached member along a portion of its length, width or otherwise. Suitable guiding feature include tracks, shafts, rails, grooves, the like or otherwise. Suitable elongated members include shafts, rods, beams, rails, the like or otherwise.

As previously mentioned, the disc transport further includes an engagement mechanism adapted to selectively engage a disc portion. The engagement mechanism includes a first finger and a corresponding second finger, which are movable, with respect to one another, along one or more axes. When combined, the first and second fingers form a diameter that generally corresponds to the disc hole 18 formed in the disc and are adapted to move relative to each other. In a first position, the fingers are in a closed position wherein the resulting diameter of the fingers is less than the diameter of the disc hole. Accordingly, the fingers can move into the disc hole without substantial interference. In a second position, the fingers separate and form a diameter that is equal to, or greater, than the diameter of the disc hole such that the fingers engage the inner walls of the disc hole to prevent the disc from disengaging from the disc transport. It should be appreciated that the fingers engage the interior walls, of the hole of the inner ring of the disc and optionally form a friction fit through an application of pressure by the fingers. Optionally, the first and/or second finger may include a tapered end portion for assisting in the alignment and insertion of the fingers into the disc hole. Movement of the first and second fingers, with respect to one another, may be achieved using any suitable drive means. Suitable drive means include mechanical, electrical, pneumatic, magnetic or otherwise.

In view of the foregoing, it should be appreciated that upon engagement with a disc, e.g., movement of the fingers from a first position to a second position, the disc can be moved along the first slide member to different regions of the disc publishing device. Accordingly, when the disc transport reaches a desired location, the engagement fingers move back to the first position, thereby resulting in the disengagement of the disc with the engagement mechanism.

The disc transport is further configured with means for movement along a second slide member that is generally perpendicular to the first slide member. Preferably, this perpendicular movement is generally vertical with respect to the disc publishing device; however, other directions are within the scope of the invention. Advantageously, this movement allows the engagement mechanism to be lowered over a disc for engagement or alignment with the same. Subsequently, the disc may be lifted away from the disc source location and moved along the first slide member, to a desired location. Upon arrival to the desired location (e.g., a print location, record location, final destination or otherwise), the disc may be lowered to a select height and disengaged for further processing of the disc or otherwise.

Similar to the movement along the first slide member, the movement along the second slide member of the disc transport may be achieved using any suitable drive means. Suitable drive means include mechanical, electrical, pneumatic, magnetism, the like or otherwise. It should be appreciated that the drive assembly may be activated in an opposite direction (e.g., from the second to the first position) to return the disc transport to its original, previous, or other position.

It should be appreciated that the distance between vertical positions of the disc transport may vary due to the changing height of stacked discs, located at the disc supply region or otherwise. Accordingly, the drive means is adapted to align one or more discs at various heights. Advantageously, the disc transport may further comprise one or more sensors for determining when the engagement mechanism is in a proper location for aligning a disc. Suitable sensors include pressure sensor, optical sensors, electro mechanical sensors, Hall Effect sensors or otherwise. By example, in one exemplary embodiment, the sensor is located on or associated with the flanges extending from the fingers of the engagement mechanism. The sensors determine when the engagement mechanism is flush or partially disposed with the disc hole so that upon the closed or open position of the first and second fingers.

The present invention is adapted to work with one or more media components of a disc-publishing device for performing multiple tasks to create a final disc product. Of these tasks, one particularly useful task includes recording information to the disc for subsequent retrieval. Such information may include music, videos, files, or other types commonly recorded through optical means. Accordingly, the disc-publishing device further includes a digital recording device adapted to record information to a disc. The recording device is configured to receive a disc from the disc transport, subsequently record information to the disc and make the disc available to the disc transport for subsequent tasks or otherwise. It should be appreciated that the information to be recorded to the disc may originated from another component, input port, as described herein, or otherwise.

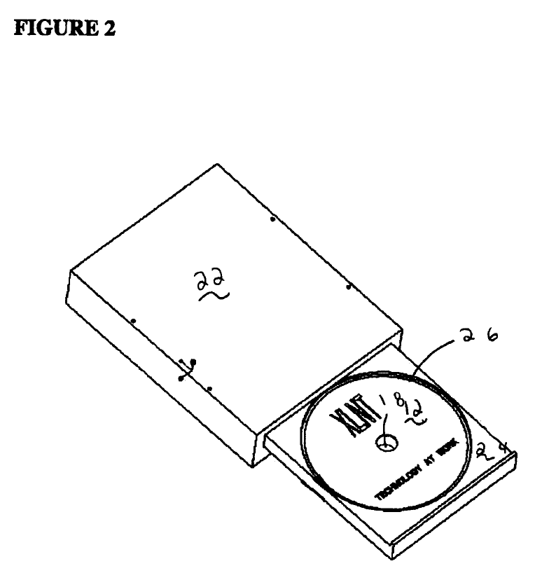

Referring to FIGS. 2-4, a suitable recording device, 22 for recording digital information to a disc is illustrated. The recording device includes a movable recording tray 24, which is adapted to reside in a retracted closed position, wherein information may be recorded, and extend to a second open position for receiving and/or providing a disc to the engagement mechanism of the disc transport. It should be appreciated that movement of the movable recording tray may be achieved using common techniques used in compact disc and digital video disc players and recording devices, or otherwise.

In operation, the recording device extends the movable recording tray to an extended open position for receiving a disc from the engagement mechanism of the disc transport. If not already located there, the disc transport moves an engaged disc to a position substantially over the tray location of the recording device, such tray location has been preprogrammed within the controller, controlling the disc transport. The disc transport lowers the disc into the movable recording tray, and the engagement mechanism releases the disc. Upon completion of recording to the disc, the movable recording tray extends to an extended open position so that the engagement mechanism of the disc transport can retrieve the disc for further processing or otherwise.

In a preferred embodiment, the movable recording tray is configured with a recess 26 having a center adapted to be substantially concentrically aligned with a disc placed therein. Accordingly, in the extended open position, the movable recording tray is adapted to receive a disc from the engagement mechanism. For example, it is contemplated that when the movable recording tray is in a fully extended open position, the recess portion is generally concentrically aligned with the center of the disc portion, (inner ring), attached to the disc transport located thereabove. In this respect, the disc transport aligns the disc to the center portion of the movable recording tray and places the disc into the tray. However, it is additionally contemplated that once the disc is disengaged from the engagement mechanism and disposed about the movable recording tray, the disc may not be concentrically aligned with the center of the movable recording tray. This is due to impart, because the recorder does not always open to same position when the movable recording tray is in the fully extended open position. Since the movable recording tray is not always opened to the same position, proper concentrically aligned placement of the disc is difficult at all times. If the disc is not properly concentrically aligned with the recess, the movable recording tray cannot fully retract into the closed position within the recording device due to the obstructing disc. As a result, the disc transport is configured with a disc alignment feature, adapted to align the disc within the movable recording tray of the recorder by subsequent movement of the disc along a first axis generally parallel to that of the disc.

Once the disc has been lowered into the movable recording tray, the disc is disengaged from the engagement mechanism and is generally positioned within the recess of the movable recording tray. After disengagement, the engagement mechanism may remain partially disposed within the hole of the disc or becomes partially disposed, so as to begin alignment of the disc within the recess of the moveable tray. Utilizing the alignment feature of the disc transport (FIG. 3), the engagement mechanism is swiftly moved back and forth in small amounts within the inner ring, thereby moving the disc in a generally parallel direction. This swift movement causes the disc to align and/or settle itself into the recess of the movable recording tray, thereby enabling the full retraction of the movable recording tray.

After the disc is settled into the recess and the disc transport raises the engagement mechanism above the disc, the movable recording tray is fully retracted without the obstruction of the misaligned disc. However, it can be appreciated that the alignment feature is capable of movement in directions other than parallel to the disc such as perpendicularly, diagonally, combinations thereof, or otherwise. Preferably, the movement of the engagement mechanism during the alignment in combination with the engagement or disengagement of a storage disc is at the most four times the diameter of the inner ring and more preferably at the most two times the diameter of the inner ring. Additionally, it is appreciated that the above described disc transfer and disc alignment method can be contemplated in other devices requiring storage disc transport and placement about a movable receiving tray such as printing, copying, displaying, or otherwise and combinations thereof.

Another useful task that may be performed with the present invention includes printing a design, text or otherwise to a disc for identification purposes, or otherwise. Accordingly, the disc-publishing device may further include a print assembly 28 adapted to print to a disc using common printing techniques (e.g., inkjet laser or otherwise). In a preferred embodiment, the print assembly includes one or more print head and ink cartridges having colors commonly associated with inkjet printing (e.g., black, white, reds, blues, greens, combinations there of as otherwise). The print heads 30 are mounted to a print slide member, which preferably extends along at least a portion of the housing and is mounted or otherwise secured thereto. It should be appreciated that the print slide member may include any of the features of the first and second slide members. The mounting of the print assembly to the print slide member provides movement along a print axis, but does not interfere with the movement of the disc transport located on the first slide member. It should be appreciated that the print head further includes a suitable drive means and linkages for movement of the print head along the print slide member. Suitable drive means and linkages may include any of the devices used for movement of the disc transport or any other suitable drive and/or linkage found in the art of disc-publishing devices and more particularly the drive configuration of print heads.

Advantageously, the print heads are adapted to print to a disc portion located within the print tray 32. Suitable print heads that can be used with the present invention can be found in the field of inkjet printing. However, printing to a disc using laser or thermal print technology is also within the present invention. In fact, it is contemplated that laser-printing technology may be used to print to a disc, which may include color. Regardless to the print means used, it should be appreciated that the disc-publishing device may print using any of the colors or color combinations found in the print industry.

The print assembly further includes a print tray adapted to receive a disc and provide movement thereabout, which preferably is substantially perpendicular to the movement of the printer heads. Advantageously, the print tray is adapted for movement along a print axis to effectuate printing. For example, the print tray is moveable to a first position, which is fully extended and a second position, which is fully retracted. It should be appreciate that during printing, the print tray will move between the first and second position to provide print capability throughout the entire disc located within the print tray. However, upon the step of removing a processed disc from the disc-publishing devices, the print tray is configured for incremental movement, which allows for a plurality of intermediate positions for the print tray that are between a “fully extended” position and a “fully retracted” position. It is further appreciated, that the print tray may extend to positions beyond the “fully extended” and “fully retracted” positions, or otherwise.

The print tray is configured with a recess having a center adapted to be substantially concentrically aligned with a disc placed therein. Accordingly, in the extended position, the tray is adapted to receive a disc from the disc transport. For example, it is contemplated that when the disc tray is in a “fully extended” position, the recess portion is concentrically aligned with the center of the disc portion attached to the disc transport located thereabove. In this respect, the print tray is positioned so that the center portion of the print tray is in alignment with the engagement mechanism, wherein the disc transport proceeds to place the engaged disc into the print tray. In one configuration, placement of the disc into the print tray comprises lowering the engagement mechanism to the position just above the print tray, releasing the disc into the tray, and raising the engagement mechanism to a first (e.g., original) position. Advantageously, the printer assembly, more specifically, the print tray may include calibration means to align the same with the engagement mechanism, thereabove.

Movement of the print tray can be effectuated using any suitable drive mechanism, and any linkage thereto, adapted for specific positioning of the print tray, which may include reciprocal movement. Suitable drive mechanisms are known in the art of printing and may include stepper motors or otherwise. In a preferred embodiment, to effectuate specific positioning of the print tray, movement of the print tray is sequenced with the movement and printing of the print head. Preferably, the movement of the print tray and the print head are effectuated through a controller adapted to cause the print tray to move to one or more positions, as discussed herein, so that the one or more print heads can print to a specified region of the disc.

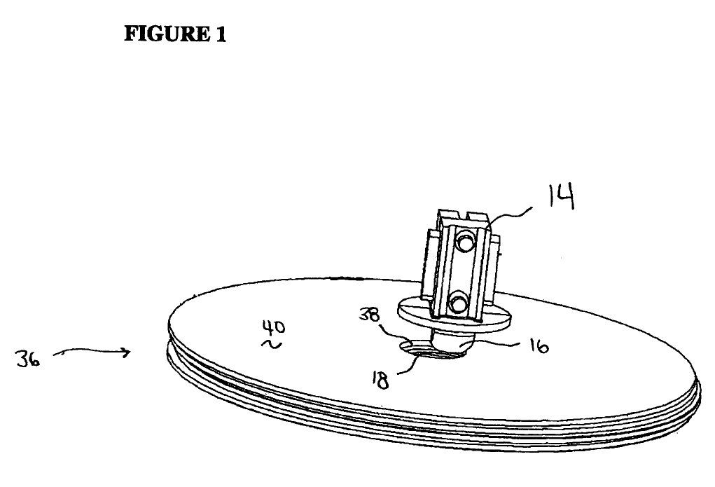

As previously mentioned, the disc publishing device may include one or more disc supply regions for storing discs prior to and/or after processing of the one or more discs. In one embodiment, the disc supply region 34 is adapted to retain one or more discs 36, which are generally, vertically stacked, (FIGS. 1, 4). The discs are usually staggered even when support rods or a basket-like device is used to hold the stack of discs in place. To compensate for the staggered discs the engagement mechanism when attempting to engage the inner ring 38 of a top disc 40, is lowered until the flanges, extending from the first and second fingers, become partially disposed within the top disc hole residing in the disc supply region.

As mentioned above, the controller controlling the disc transport is additionally and preferably programmed with the general location of the disc hole positioned within the disc supply region. However, if the discs are staggered, the actual location of the top disc hole will slightly differ from the preprogrammed location of the top disc hole, which may result in the engagement mechanism failure to engage the top disc within the disc supply region. To accommodate this situation, the disc transport, in attempting to dispose the engagement mechanism within the inner ring of the top disc, utilizes an alignment feature, which swiftly moves the engagement mechanism in a generally parallel direction to that of the individual top disc while applying a slight force, generally perpendicular to the individual top disc. As such, the first and second fingers of the engagement mechanism eventually dispose themselves within the inner ring of the top disc, thereby aligning at least the top disc for engagement thereof. However, it can be appreciated that the alignment feature is capable of movement in directions other than parallel to that of the disc such as perpendicularly, diagonally, combinations thereof, or otherwise. Thereafter, the disc transport is able to engage the top disc for transfer to a target location.

Optionally, the disc transport may include a calibration means for aligning the engagement mechanism of the disc transport with various component of the device including the disc supply or storage regions (or disc), the movable recording trays associated with a print or recording device, combinations thereof or otherwise. As such, it is contemplated that the disc transport and/or engagement mechanism may be configured for alignment movement in one, two, three, or more directions. Similarly, it should be appreciated that these components may be configured for rotation about one or more axes.

In one configuration, the calibration of the disc transport, and hence the engagement mechanism, is achieved automatically as part of the control functions of the device or otherwise. Optionally, the calibration may also be achieved manually, wherein the disc transport or engagement mechanism is configured for adjustable movement as previously describe. Of course, it should be appreciated that the any of the components may be configured for both automatic and manual adjustment.

The calibration of the components of the device may be performed during manufacturing of the same and/or after manufacturing by the user of the device. Optionally, the device further includes one or more sensors for determining the position of the disc transport with respect to other components of the device. In doing so, disc transport may be adjusted based upon known points of the other components in order to align the engagement mechanism with the other component.

In one embodiment, the one or more discs located within an engagement area, such as a disc supply region, a movable tray of a media component or otherwise, may be properly positioned/aligned within the engagement area along an engagement axis, preferably along a preprogrammed engagement axis. However, the disc engagement mechanism located thereabove may be misaligned with the engagement axis and/or the one or more discs therebelow, thereby imposing the engagement of the one or more disc. Optionally or as an alternative to the calibration means, the disc transport may utilize the alignment feature as discussed herein to locate the disc hole therebelow. Similarly, the disc transport is lowered thereby positioning the engagement mechanism proximate to the disc hole wherein the disc transport swiftly moves the engagement mechanism in a generally parallel direction to that of the top disc therebelow while applying a slight downward force, generally perpendicular to the top disc. As the fingers of the engagement are swiftly moved generally parallel to the top disc while applying a slight perpendicular force, at least a portion of the engagement fingers will slide into the inner ring, (hole), of the top disc. The movements will continue until the engagement fingers are properly disposed within the disc hole. As such, the first and second fingers of the engagement mechanism eventually align themselves with the inner ring of the top disc for engagement thereof.

In a preferred embodiment, disc transport is controllable through a controller. The controller may be included with the disc transport, e.g. not incorporated within the device, or alternatively, the controller of the device may be included as a component of the device. However, in a preferred embodiment, the controller is adapted to receive a signal from a source, such as a computer or otherwise, such that function of the print device is based upon the received signal. Furthermore, preferably the controller causes synchronized operation of the components of the device (e.g., printing, recording, movement or otherwise) to maximize print efficiency by minimizing cycle time of any task to be performed.

In one exemplary method, the operation of the disc publishing device is demonstrated as follows. A user selects one or more tasks to be performed by the device, via a user interface. As previously mentioned, such tasks may include recording to a disc, printing to a disc, or both. The user interface may be located proximate to the device or remote to the device (e.g., via a network connection, Internet or otherwise). It should also be appreciated that the user interface may comprise an integral component of the disc publishing device, (e.g., located externally or otherwise). Prior to assignment of a task to be performed by the disc publishing device, the user places one or more discs at the disc supply region. Optionally, the amount of discs placed in the disc storage region corresponds to the desired selected storage devices the user wishes to perform tasks to.

Through the user Interface, the user selects one or more tasks to be performed to one or more discs. Often, as discussed below, the task includes both the recording and printing of information. For example, the tasks may include transferring data from a source to one or more discs, in a digital format. In addition, the tasks may also include printing to the recorded discs, which advantageously corresponds to the information transferred to the disc. Once the tasks have been selected, one or more signals are transferred to the controller of the disc publishing device to effectuate synchronized operation of the print device corresponding to the tasks requested.

For example, in one method of operation, upon transmission of the task signal to the disc publishing device, the disc transport moves along the first slide member to the disc supply region, wherein the engagement mechanism is positioned over the holes of the one or more discs located therebelow in the supply region, which is adapted to receive and/or store a plurality of discs. The engagement mechanism is lowered along the second slide member until the flanges, extending from the engagement fingers, become generally flush with the top disc residing in the supply region. The engagement fingers are then separated so that the top disc is separated from the adjacent disc residing in the one or more supply regions.

Advantageously, the alignment features allows for greater versatility of the disc transport by, in one example, in an effort to engage a first storage disc from a stack of staggered storage discs, the disc transport is able to locate the inner ring of the first storage disc, which is misaligned from the typical/preprogrammed location as a result of being in a staggered position. Furthermore, this combination of features allows for a subtle range of motion, particularly generally parallel and slightly perpendicular to that of the storage disc, such that the amount of movement by the disc transport enables the disc transport to locate and at least partially dispose the engagement mechanism within the inner ring of the storage disc swiftly and efficiently without resulting in a disc pick failure.

More specifically, if the one or more discs located within the disc supply region are staggered, the flanges of the engagement fingers may not be able to become generally flush with the top disc because of a staggered adjacent disc therebelow. Utilizing the alignment feature, the disc transport will move the engagement mechanism to the preprogrammed general location of the disc hole located within the disc supply region. In attempting to dispose the engagement mechanism within the inner ring of the top disc, the disc transport utilizes the alignment feature, which swiftly moves the engagement mechanism in a generally parallel direction to that of the individual top disc while applying a slight force, generally perpendicular to the individual top disc, thereby aligning at least the top disc for engagement thereof. As such, the first and second fingers of the engagement mechanism eventually dispose themselves within the inner ring of the top disc. Advantageously, these movements may further align the one or more discs beneath the top disc, thereby aligning the next disc for future engagement and transport. Thereafter, the engagement mechanism is able to engage the top disc for transfer to a target location.

The disc is moved along the first slide member to one of the recording devices. Preferably, the recording tray of the recording device is extended so that the center portion of the disc attached to the engagement mechanism is substantially aligned with the center of the recording tray of the recording device. The engagement mechanism is then lowered along the second slide member proximate to the recording tray and disengages the disc. Optionally or as an alternative, if the center portion, (inner ring), of the disc attached to the engagement mechanism is not substantially aligned with the center of the movable recording tray of the recording device and the disc is disengaged into the recording tray, the disc may not settle into the recess of the recording tray, which may prevent the movable recording tray from fully retracting. Utilizing the alignment feature of the disc transport, the engagement mechanism is swiftly moved back and forth in small amounts while partially disposed within the inner ring of the disc in a generally parallel direction to the disc, thereby moving the disc in the same general direction. This swift movement of the engagement mechanism causes the disc to align and/or settle itself into the recess of the recording tray, thereby enabling the recording tray to fully retract to the closed position.

Upon placement of the disc into the recess formed on the recording tray, the engagement mechanism returns to an original position and the recording tray retracts into the recording device, wherein information is then recorded onto the disc. The operation of transferring discs to the plurality of recording devices is repeated until each recording device is in use; the entire task is complete, or otherwise.

Upon completion of recordation of data to the disc, the recording tray extends and the disc engagement mechanism lowers and once again engages the disc and raises it to the original position. The disc printing tray then moves into an extending position and the disc transport, if necessary, aligns the center of the disc with the center of the recess formed in the disc-printing tray. The engagement mechanism then lowers the disc onto the print tray in a similar fashion that was performed with the disc-recording device. Optionally or as an alternative, the disc transport may utilize the alignment feature to align the disc within the movable print tray in a similar fashion that was discussed pertaining to the movable recording tray of the recording device, if the disc is misaligned about the movable print tray once disengaged. Once aligned, the disc transport returns the engagement mechanism to an upward portion.

The disc-printing tray then moves in synchronization with the print heads of the print assembly to effectuate printing to the surface of the disc. During this process, because of the decoupling of the disc transport and the print assembly, the disc transport moves back to the disc supply cartridge to retrieve another disc and place the disc into one of the empty disc recording devices as discussed above. It should be appreciated that this may be performed during printing to the disc.

Upon completion of the printing to the disc, and advantageously during recordation of data to the disc located in the recording device, the print assembly tray extends to its extended position. The disc transport then aligns itself with the disc located in the print tray, if necessary, and engages the completed disc. The disc is then transported to the one of the one more storage regions.

It is contemplated that prior to engaging the completed disc, the engagement mechanism, the movable tray (e.g., of the print assembly, the recording device, the like or otherwise) including the completed disc, or both may be misaligned with respect to the engagement axis. As such, at least one of the engagement mechanism or the movable tray is moved in a generally parallel direction to that of the completed disc while the engagement mechanism applies a generally perpendicular force to that of the completed disc until the engagement mechanism becomes at least partially disposed with the hole of the completed disc. Once the engagement mechanism is at least partially disposed within the hole of the completed disc, the engagement mechanism engages the completed disc. In other words, the movable tray (including the completed disc) moves back and forth (e.g., retracts or extends) to generally align the hole of the completed disc with the engagement mechanism, the engagement axis, or both. Preferably, the engagement mechanism applies a generally downward force to the top surface of the completed disc while the movable tray is moving back or forth until the engagement mechanism becomes at least part partially disposed within the hole of the completed disc for engagement thereof.

It should be appreciated that this cycle continues until the all of the selected tasks have been completed or the discs from the disc supply region has been exhausted.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only three of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. An apparatus for aligning a disc, the apparatus comprising:
a disc transport movable along at least one axis, the disc transport including:
a disc engagement mechanism adapted for selective engagement of at least one disc; and
at least one engagement area including the at least one disc having a disc hole, wherein the at least one disc is generally misaligned with the at least one engagement area, one or more discs therebelow, the disc engagement mechanism thereabove, or combinations thereof;
wherein the engagement mechanism, the engagement area including the at least one disc, or both is moved in a generally parallel direction to that of the at least one disc while:
(a) the engagement mechanism applies a generally perpendicular force to that of the at least one disc until the engagement mechanism becomes at least partially disposed within the hole of the at least one disc,
(b) the engagement mechanism is at least partially disposed within the hole of the at least one disc to generally align the at least one disc with the at least one engagement area therebelow, the one or more discs therebelow, an engagement axis, or combinations thereof;
(c) or both.

2. The apparatus of claim 1, wherein the at least one engagement area is at least one media component for processing the at least one disc, the at least one media component having a movable tray adapted to receive the at least one disc from the disc transport.

3. The apparatus of claim 2, wherein the movable tray includes a recess that is adapted for receiving a first disc, the recess providing support and placement for the first disc, which enables the movable tray to retract within the recording device with the first disc therein.

4. The apparatus of claim 2, wherein the at least one media component is a printer assembly adapted for printing to the at least one disc, the print assembly including:
one or more print heads movable about a print axis; and
a movable print tray adapted to receive the at least one disc from the disc transport;
wherein the disc transport and the one or more prints heads are adapted to move independent of each other.

5. The apparatus of claim 2, wherein the at least one media component is a recording device adapted for recording to the at least one disc, the at least one recording device including:
a movable recording tray adapted to receive and record to the at least one disc from the disc transport;

6. The apparatus of claim 1, wherein the at least one engagement area is a disc supply region and the at least one disc includes a staggered top disc having first inner ring defined by a first hole and a staggered bottom disc therebelow having a second inner ring defined by a second hole and wherein the first and second inner rings of the top and bottoms discs are misaligned, so as to prevent engagement of the top disc.

7. The apparatus of claim 1, wherein the hole of the at least one disc is in general alignment along the engagement axis and is generally misaligned with the engagement mechanism, so as to prevent engagement of the at least one disc.

8. The apparatus of claim 1, wherein the movement of the engagement mechanism that is generally parallel to that of the at least one disc is from about 2 to about 4 times the diameter of the disc hole.

9. A method of aligning one or more discs comprising the steps of:
providing a disc transport having a disc engagement mechanism, a disc supply region having at least one staggered disc, each staggered disc having an inner ring defining a hole;
moving the engagement mechanism in a generally parallel direction to that of the at least one staggered disc, while applying a slight downward force, thereby generally locating the disc hole of the at least one staggered disc; and
aligning the at least one staggered disc, the engagement mechanism, or both with an engagement axis.

10. The method of claim 9, wherein the step of moving the engagement mechanism further comprises the step of partially disposing the engagement mechanism within the hole of the at least one staggered disc prior to aligning.

11. The method of claim 9, wherein the at least one staggered disc includes a top disc and an adjacent bottom disc therebelow, the inner rings of the top and bottom discs being in misalignment thereby preventing engagement of the top disc.

12. The method of claim 11, wherein the moving step generally aligns the inner ring of the top disc thereby enabling the engagement mechanism to partially dispose itself within the hole of the top disc for engagement thereof.

13. The method of claim 11, wherein the moving step generally aligns the inner ring of the bottom disc so that the top disc can be engaged.

14. The method of claim 9, wherein the step of moving, the engagement mechanism moves generally parallel to that of the at least one disc from about 2 to about 4 times the diameter of the disc hole.

15. A method of aligning one or more discs: comprising the steps of:
providing a disc transport having a disc engagement mechanism; and at least one media component having a moveable tray;
disengaging a disc having a hole onto the movable tray of the media component;
moving the engagement mechanism about the disc hole along an axis generally parallel to the disc, thereby moving the disc about the movable tray for alignment therein.

16. The method of claim 15, wherein after the step of disengaging the disc, the method further comprises the step of either maintaining the engagement mechanism partially disposed within the disc hole or partially disposing the engagement mechanism within the disc hole.

17. The method of claim 15, wherein the movable tray includes a recess adapted for receiving the disc.

18. The method of claim 17, wherein the step of disengaging the disc onto the recess, the disc becomes misaligned with the recess.

19. The method of claim 18, wherein the step of moving the engagement mechanism about the disc hole, the disc becomes aligned with the recess, thereby enabling the movable tray to retract with the disc aligned therein.

20. The method of claim 15, further comprising the steps of removing the engagement mechanism from the hole of the disc and retracting the movable tray within the media component with the aligned disc therein for processing.
